(19) United States
(12) Patent Application Publication
(10) Pub. No.: US 2010/0064738 A1
(43) Pub. Date: Mar. 18, 2010

(54) LOCK BODY WITH INTEGRAL COMPONENTS

(76) Inventor: CHEN MAO YI, TAIWAN (TW)

Correspondence Address: SHERIDAN ROSS PC, 1560 BROADWAY, SUITE 1200, DENVER, CO, 80202, US

(21) Appl. No.: 12/210,027

(22) Filed: Sep. 12, 2008

(51) Int. Cl. E05B 37/00

(52) U.S. Cl. 70/24

(57) ABSTRACT

A lock is disclosed having components formed integrally with a lock body. One example of such an integrally formed component is a biasing member utilized in the operation of a combination locking mechanism. A lock is also disclosed having an inner and outer body. A variety of outer bodies of different aesthetic appearance may be utilized with the same inner body. The lock disclosed herein may be embodied in a variety of styles, one of which is a padlock.

### FIELD OF THE INVENTION

One aspect of the present invention generally relates to locks, including padlocks, luggage locks, zipper locks and any other types of locks which use a combination locking mechanism in which component hardware may be integrated into a housing and thereby reduce the number of component pieces, simplify assembly and reduce cost. Another aspect of the present invention, also involving locks, utilizes one or more locking mechanisms, including combination actuated locking mechanisms, key actuated locking mechanisms or other lock mechanisms which locking mechanisms are integrated into a housing structure comprising inner and outer housings for purposes of providing aesthetic variety to a single locking mechanism to also simplify assembly and reduce cost.

### BACKGROUND OF THE INVENTION

Manufacturers of locks, including various types or embodiments of locks always seek ways to reduce costs and simplify manufacturing and assembly of their lock products. If the price of manufacturing the component pieces of a lock can be reduced and the costs related to the assembly of the lock components into a final lock product can also be reduced, the manufacturer will achieve savings, resulting in increased profits for the manufacturer and/or lower costs for the consumer. For example, U.S. Pat. No. 7,174,756, the entirety of which is incorporated herein by reference, discloses a padlock having dual, independently operated locking mechanisms. The combination locking mechanism includes a plurality of numbered annular dials, each concentrically positioned about a complementary sleeve or lock cylinder through which a leg of a shackle is positioned. Additionally, an alignment or spring is associated with each dial for purposes of stabilizing the position and movement of each dial and provides tactile feedback to the user of the lock as the dials are moved. A compression spring is also typically associated with the lock cylinders to allow the lock cylinders to move relative to the dials and also to bias the position of the lock cylinders to a particular position. Similarly, a compression spring is also used as part of the key lock mechanism to bias the position of the key lock mechanism relative to the housing. Other lock types have similar mechanical structures comprising numerous component pieces. In every case, the numerous manual pieces must be individually made and manually assembled. As a result, reducing the number of component pieces will reduce manufacturing and assembly costs.

In addition, it is often expensive to vary the exterior appearance or aesthetics of a lock. For example, if a lock manufacturer desires to market a combination lock to different consumers by altering the appearance of the lock, the manufacturer will typically need to change the tooling or molds for making the respective housings of the different locks have a different exterior appearance. However, changes to the housing may require changes to the locking mechanism in order to accommodate the changes to the housing. Thus there is also a need in the industry to reduce costs when changing the exterior appearance of lock while simultaneously reusing existing locking mechanisms without change.

### SUMMARY OF THE INVENTION

The present invention satisfies a long-felt need to simplify the manufacturing and assembly processes associated with mechanical locks. In one embodiment of the present invention, what were once separate component pieces are now integrally formed as part of an internal housing for the lock. For example, leaf springs for positioning and providing tactile feedback in the movement of the individual dials of a combination lock are formed integral with the housing. Similarly, compression springs used with both combination and key locks may be formed integral with the housing. For example, a spring for maintaining the position of the dials relative to corresponding lock cylinders while also permitting separation of the lock cylinders from the dials for purposes of resetting the combination also may be formed integral with the housing. Other components may also be formed integrally with the lock housing as would be appreciated by those of skill in the art upon review of this disclosure. Additionally, the housing with these integral components may be made from plastic. As a result, the number of component pieces required for manufacture of a lock is reduced and the assembly process is simplified. This results in a lower cost product.

A further aspect of some embodiments of the present invention is that the concept of integrally incorporating component pieces into a lock housing may be implemented with an inner housing and an outer housing. Alternatively, the concept may be employed in a lock having a single housing. It is also contemplated that a housing, as that term is used herein, may have more than two constituent parts even though the specific embodiments illustrated herein show each housing made from two pieces.

Another aspect of the present invention includes providing a second or outer housing or shell over an inner housing. The outer housing may be made of plastic, metal or a combination of both. The outer housing provides the manufacturer with the opportunity to change and vary the aesthetic look of a lock while maintaining the internal components identical from one lock to the next. Thus, manufacturers may provide consumers with a choice of differently appearing locks while reducing inventory and manufacturing costs by utilizing the same internal components.

### DESCRIPTION OF THE DRAWINGS

Several drawings have been developed to assist with understanding the invention. Following is a brief description of the drawings that illustrate the invention and its various embodiments.

FIG. 1 is a perspective view of one type of lock incorporating features of the present invention.

FIG. 2 is an exploded view of the lock of FIG. 1.

FIG. 3 is a top plan view of the dual locking mechanisms shown in FIG. 2.

FIG. 4 is an exploded perspective view of the inner housing shown in FIG. 2.

FIG. 5 is a front plan view of the inside surface of one-half of an inner housing.

FIG. 6 is a cross-sectional view taken along line 6-6 of FIG. 5.

FIG. 7 is a cross-sectional view taken along line 7-7 of FIG. 5.

FIG. 8 is a front plan view of the dual locking mechanisms positioned in one-half of an inner housing as shown in FIG. 2, with the locking mechanisms in a locked state.

FIG. 9 is a cross-sectional view taken along line 9-9 of FIG. 8.

FIG. 10 is a cross-sectional view taken along line 10-10 of FIG. 8.

FIG. 11 is a front plan view of the dual locking mechanisms and an inner housing shown in FIG. 8 with the combination locking mechanism unlocked and the shackle rotated and depressed to permit changing of the combination.

It should be understood that the drawings are not necessarily to scale, and that in certain instances, the disclosure may not include details which are not necessary for an understanding of the present invention, such as conventional details of fabrication and assembly, by those of skill in the art. Also, while the present disclosure describes the invention in connection with those embodiments presented, it should be understood that the invention is not strictly limited to these embodiments.

### DETAILED DESCRIPTION

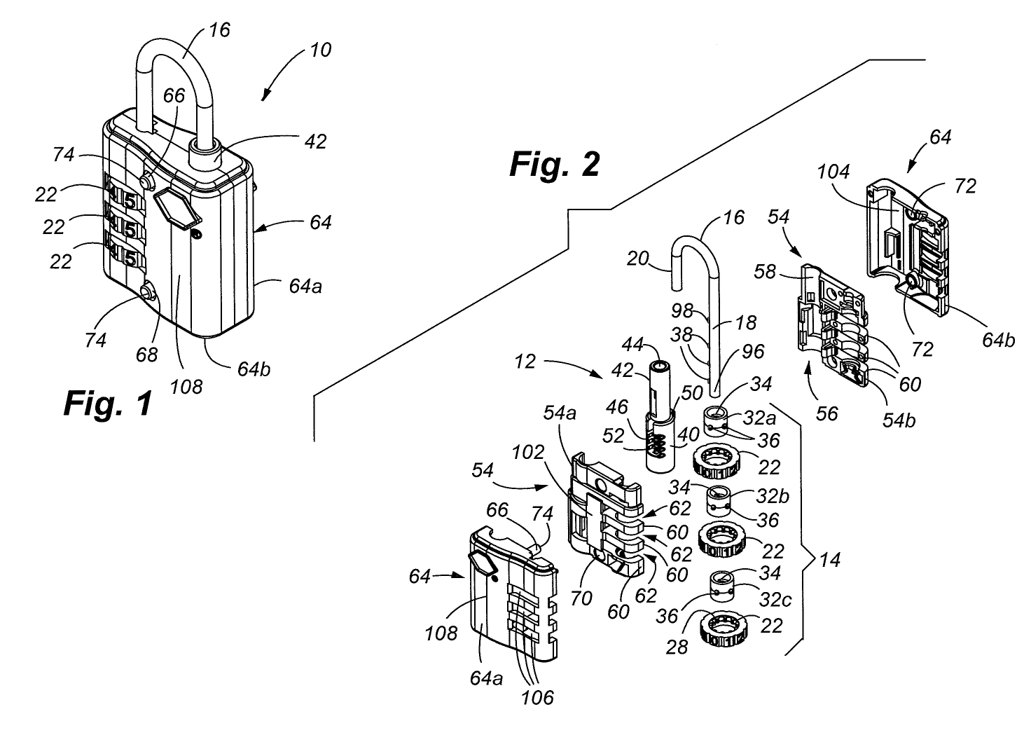

A lock 10 incorporating features of the present invention is shown in FIG. 1. It should be appreciated that the concepts and features of the present invention have applicability in a variety of lock styles, not just padlocks. For example, zipper locks, strap locks, luggage locks, or any style of lock using a combination locking mechanism may benefit from adoption of the features and concepts of the present invention. The lock 10 of FIG. 1 is one embodiment of the present invention and is used for illustrative purposes and should not be construed as limiting the scope of the invention. Although not visible in FIG. 1, the lock 10 includes two locking mechanisms, a key operated locking mechanism and a combination operated locking mechanism. It should be appreciated that only one locking mechanism may be used, or that two or more locking mechanisms may be used. When multiple locking mechanisms are used, they may be of the same type or different. For example, the locking mechanisms may be key locking mechanisms, combination locking mechanisms, biometric locking mechanisms, electronic locking mechanisms, magnetic locking mechanisms or other locking mechanisms known to those of skill in the art. It should also be appreciated that a combination operated locking mechanism used with aspects of the present invention is not limited to three dials axially aligned. The combination operated locking mechanism may have one or more dials and the dials need not be axially aligned.

Turning to FIG. 2, the lock of FIG. 1 is shown in an exploded view. The key operated locking mechanism 12 and the combination locking mechanism 14 both operate in combination with a J-shaped rigid shackle 16. One leg 18, the long leg of the shackle 16, interacts with the combination operated locking mechanism 14, and the second leg 20, the shorter leg, interacts with a key operated locking mechanism 12. It should be appreciated that the shackle need not be J-shaped or rigid. For example, a flexible cable or chain may be used in place of the rigid shackle 16. It should further be appreciated that a shackle is not needed either. The concepts of the present invention will work with a variety of latching mechanisms.

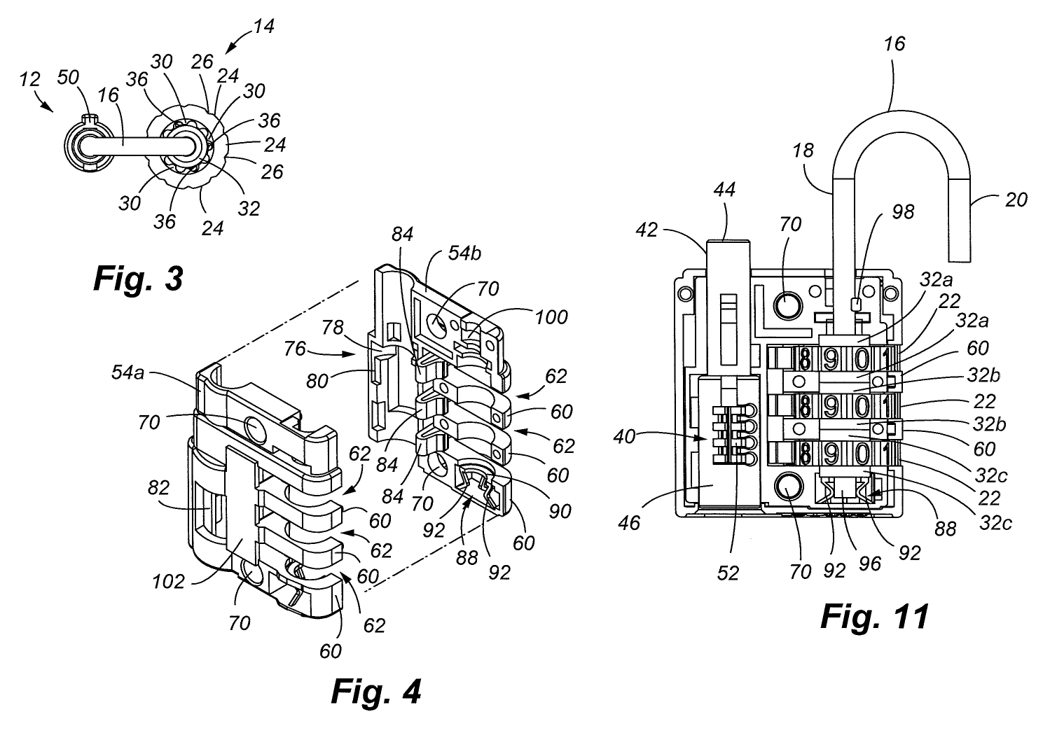

The combination operated locking mechanism 14 controls the axial movement of the second leg 20 of the shackle 16. The combination operated locking mechanism 14 comprises three annular dials 22. The outer surface of the dials 22 includes a series of raised surfaces 24, each containing a different number. Here, the numbers are 0-9, but it should be appreciated that other numbers or symbols may be used instead. Each raised surface 24 is separated from the adjacent raised surfaces by a groove or notch 26. With reference to FIGS. 2 and 3, the inner surface 28 of the dials 22 comprises a series of spaced teeth 30. A separate lock cylinder or sleeve 32 is positioned in the opening 34 of each of the dials 22. The exterior surface of each lock cylinder 32 includes a series of teeth 36 which engage the teeth 30 formed on the inner surface of the dials 22. Thus, as the dials 22 are turned, the corresponding lock cylinder 32 is also turned.

The long leg 18 of the shackle 16 passes through the interior of the lock cylinders 32. The shackle leg 18 has four protrusions or tabs 38 extending outwardly, the lower most three of which interact with the lock cylinders 32 to prevent axial movement of the shackle relative to the lock cylinders 32. As is known to those of skill in the art, an axial groove or notch is formed in the interior of each lock cylinder 32 such that when all of the grooves are axially aligned, the shackle 16 may be lifted to an unlocked position. Conversely, if any one of the notches is not properly aligned with its corresponding tab 38, the shackle 16 cannot be raised and the shackle 16 cannot be unlocked. The grooves in the interior of the lock cylinders 32 are moved relative to the shackle 16 by rotation of the dials 22 which causes rotation of the lock cylinders 32.

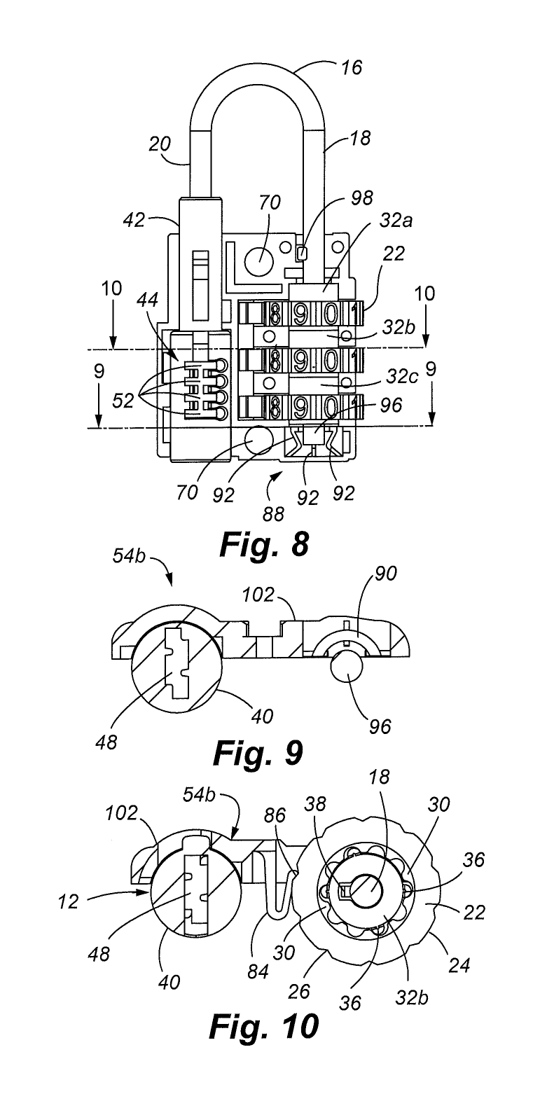

The key operated locking mechanism 12 secures the first or short leg 20 of the shackle 16. The key operated locking mechanism 12 generally comprises a latching tube 40 and a stop member 42. A recess 44 is formed in the stop member 42 and receives the end of the short leg 20 of the shackle 16. As shown in FIGS. 2 and 8, the latching tube 40 includes a disk tumbler cylinder 46. Alternatively, a pin tumbler cylinder or other mechanisms for performing similar functions as known to those of skill in the art may be used instead of the disk tumbler cylinder. The disk tumbler cylinder 46 is provided with a plurality of disks (not shown), a key way 48 (shown in FIG. 9) for receiving a key and an outwardly extending tab or block 50. The disks are positioned within the cylinder 46, with the peripheral edges thereof retractably extending from the cylinder 46 through openings 52. The block 50 is mounted on the exterior surface of the cylinder 46 and, in the illustrated embodiment, is located above the disks. The key hole 48 is accessed on the bottom of the cylinder 46 and controls the movements of the disks in a way that when an authorized key is inserted into the key hole 50, the peripheral edges of the disks are retracted into the interior of the cylinder 46. Conversely, when the key is withdrawn from the key hole 50, the peripheral edge of the disks extend out of the openings 52.

Referring primarily to FIGS. 2 and 4, the two locking mechanisms are contained within an inner housing 54, which in the preferred embodiment comprises two halves 54a and 54b. A recess or chamber 56 is formed on the interior wall 58 of each of the two halves 54a and 54b of the inner housing 54 to accommodate the key operated locking mechanism 12. The interior wall 58 of the inner housing 54 is also shaped to accommodate the combination operated locking mechanism 14. Each half 54a and 54b of the inner housing 54 includes a series of aligned arms 60 for engaging and supporting the combination operated locking mechanism 14, and more particularly the lock cylinders 32. The arms 60 are spaced apart by a series of slots or cut outs 62 through which the dials 22 of the combination operated locking mechanism are positioned and may be rotated (FIG. 8). The inner housing is preferably made of plastic, such as a polyether or polyactel resin type. It may also be made from metal, such as steel, stainless steel, brass, copper, aluminum and/or an aluminum alloy.

An outer housing 64 is also illustrated in FIG. 2. In the preferred embodiment, the outer housing 64 is comprised of two halves 64a and 64b, and is adapted to fit over the exterior of the inner housing 54. A pair of posts 66 and 68 extend through apertures 70 in the opposed halves 54a and 54b of the inner housing 54, the distal ends of which are received in a pair of complementary apertures 72 formed in the opposing half 64a of the outer housing 64. The distal ends 74 of the posts 66 and 68 are secured within the apertures 72, for example by welding, to interconnect the outer housing 64a, thereby securing the inner housing 54 and lock mechanisms 12 and 14 in a single body. The outer housing is preferably made of metal, such as steel, stainless steel, brass, copper, aluminum and/or an aluminum alloy. Alternatively, it may also be made of plastic, such as a polyether or polyactel resin type.

Turning to FIG. 4, the interior wall 58 of the inner housing 54 surrounding the latching tube 40 includes a substantially L-shaped slot 76 in which the block 50 is positioned when the lock is assembled. The L-shaped slot 76 comprises a transverse slot 78 and a longitudinal slot 80 which control movement of the block 58. A recess 82 is also formed in the inner housing 54a and receives the peripheral edges of the disk tumblers when they extend from the cylinder 46 of the latching tube 40. When the peripheral edges of the disk tumblers are retracted and nested within the cylinder 46, the latching tube 40 is able to rotate relative to the inner housing 54 and the block 50 is allowed to move along the transverse slot 78 and the longitudinal slot 80. By inserting a key into the key hole 48, the peripheral edges of the disk tumblers are retracted within the cylinder 46 and disengage the recess 82. Turning the key moves the block 50 from the first end 78a of the transverse slot 78 to the second end 78b of the transverse slot 78. The key is then pulled downwardly to move the block 50 along the longitudinal slot 80 and to lower the latching tube 40 relative to the lock body. As the latching tube 40 is lowered, the stop member 42 is also lowered and ultimately the recess 44 formed in the distal end of the stop member 42 disengages the second or short leg 20 of the shackle 16. At this point, the shackle is able to rotate about the first or long leg 18 allowing the shackle to engage or disengage another object. A spring may be provided to bias the latching tube either to a retracted position inside the lock body where the stop member 42 is disengaged from the shackle to an extended position where the stop member 42 secures the shackle 16. The biasing spring may be a separate component or it may be integrally formed with the inner housing as explained in greater detail below.

To move the padlock back to a locked state, a user rotates the second end 20 of the shackle 16 to align with the recess 44 in the stop member 42. The key is then pushed upward to move the block 50 along the longitudinal slot 80 and the latching tube 40 upward until the stop member 42 captures the second end 20 of the shackle 16. The key is then turned to move the block 50 until it reaches the first end 78a of the transverse slot 78 and then the key is withdrawn. It should be appreciated that the latching tube 40 and stop member 42 of the illustrated embodiment may be configured in other ways. For example, the stop member 42 may include a slot formed at its distal end that permits the second leg 20 of the shackle 16 to rotate out of the stop member 42 without the stop member 42 being lowered. Instead, the stop member rotates between a first position and a second position with rotation of the key. In the first position the shackle is unable to rotate, but in the second position the slot formed in the distal end of the stop member 42 is aligned with the path of rotation of the shackle 16 such that the second leg 20 may rotate through and out of the stop member 42 without retracting the latching tube 40 and stop member 42. Such a mechanism is shown in U.S. Pat. No. 7,174,756, the entirety of which is incorporated herein by reference.

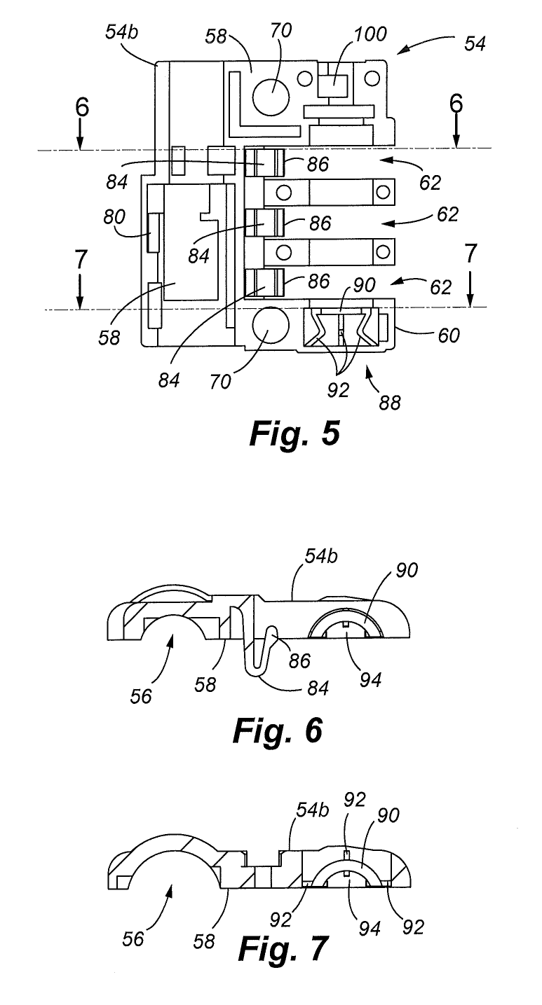

With reference to FIGS. 2 and 4-6, three leaf springs 84a, 84b and 84c are visible. The leaf springs 84 are aligned with the slots 62 formed in the inner housing 54 for accommodating the dials 22. In the illustrated embodiments, and as also shown in FIG. 10, the leaf springs 84 are generally U-shaped members formed with an enlarged protrusion or lip 56 at the free end. The lip 86 is designed to mate with grooves 26 formed in the outer surface of the dials 22. The leaf springs 84 provide tactile feedback to the user upon rotating the dials 22 and also function to secure the position of the dials 22 so that the user may accurately position any desired set of numbers. One important aspect of the leaf springs 84 is that they are formed integral with the inner housing 54b. By integrally forming the leaf springs 84 as part of the inner housing 54, a separate component piece is eliminated from the lock, making assembly easier and reducing the cost of the overall lock. It should be further appreciated that the leaf springs 84 are not limited to a generally U-shaped configuration. While the U-shape provides resilience and flexibility, other shapes are within the scope of the invention. For example, other shapes include linear, curved or bowed. Also, the lip 86 may be formed with sloped or angled walls to facilitate rotation of the dials.

Turning to FIGS. 4 and 7-9, a second feature of the present invention is shown. A compression spring 88 and seat 90 are formed integrally with the inner housing 54a and 54b. The compression spring 88 and seat 90 as illustrated are designed for operation in association with the combination lock mechanism 14. The integral spring 88 is formed in two generally semi-circular or semi-cylindrical portions due to the inner housing 54 being formed with two halves 54a and 54b. A semi-circular seat 90 is formed integral with a plurality of biasing members or legs 92 which, in turn are formed integrally with the two halves 54a and 54b of the inner housing 54. The biasing members 92 are designed to retain their shape and to impart an expansive force when compressed. As seen in FIGS. 2 and 10, the illustrated embodiment utilizes three lock cylinders 32a, 32b and 32c. The seat 90 is designed to support the bottom lock cylinders 32c, which aligns all three lock cylinders 32a, 32b and 32c. The two halves of the seat 90 form an annular shape with a center aperture 94 designed to receive the distal end 96 of the long leg 18 of the shackle 16. Thus, when at rest and assembled as shown in FIG. 8, the compression spring 88 and seat 90 support the alignment of lock cylinders 32 of the combination operated locking mechanism 14 such that the combination operated locking mechanism works properly.

The compression spring 88 also assists in the resetting of the combination of the combination lock 14. In such an operation, the dials 22 must be axially separated from the associated locking cylinder 32 to allow the numbers or symbols on the dial 22 to be shifted relative to the locking cylinder 32. In the embodiment of FIG. 11, the first or long leg 18 of the shackle 16 is pressed downwardly against the biasing action of the spring 88 and rotated such that the tab 98 formed on the upper portion of the leg 18 engages a slot 100 formed in the inner housing 54b. When engaged in this manner, the shackle 16 is prohibited from moving axially relative to the combination operated locking mechanism 14. FIG. 11 shows the shackle 16 in this depressed position. Compared to FIG. 8, the distal end of the shackle leg 18 has moved downwardly. The locking cylinders 32a, 32b and 32c have also moved downwardly with the shackle 18 but the dials 22 remain in their original position. The teeth 30 on the inside surface 28 of the dials 22 are disengaged from the teeth 36 on the locking cylinders 32. The dials 22 may now be rotated to permit the combination to be changed. Upon setting of the dials 22 to a new combination, the shackle 16 is rotated until the tab 98 is released from the slot 100 and the compression spring 88 forces the shackle 16 upward relative to the padlock to align the teeth 30 on the dials 22 with the teeth 36 on the cylinders 32. Rotating the shackle until the upper most protrusion 98 is released causes the integrated compression spring 88 to move the lock cylinders 32 back into engagement with the dials 22 as shown in FIG. 8 and to set the new combination. By forming the compression spring 88 and seat 90 integrally with the inner housing 54, another separate component piece is eliminated, assembly is simplified and costs are lowered.

Yet another aspect of the present invention is the ability to utilize differently appearing outer housings 64 with the same inner housings 54. Accordingly, the outer surfaces 102 of the inner housing 54 and the inner surface 104 of the outer housing 64 must be compatible for assembly purposes. For example, the outer housing 64 must include slots 106 to permit access to the dials 22. Otherwise, the exterior surface 108 of the outer housing 64 may vary and lock manufacturers may provide aesthetically different locks that utilizes the same inner housing and lock mechanisms. Inner housings and lock mechanisms may be preassembled and outer housings added and assembled with customer orders. This allows the lock manufacturers to reduce the number of different component parts used in making locks, affording the manufacturer additional savings.

Although this invention has been disclosed and illustrated with reference to particular embodiments, the principles involved are susceptible for use in numerous other embodiments that will be apparent to persons skilled in the art. For example, aspects of the invention may use a biasing spring to bias the key operated locking mechanism either in an open or closed position or to integrally incorporate other components from biometric, magnetic or electronic locking mechanisms into a housing for the lock. Further still, a separate biasing spring could be associated with each dial of a combination lock. Any need for a biasing action, lever arm, etc. could be satisfied with an integrally formed biasing member. This invention is, therefore, to be construed only as indicated by the scope of the claims and not limited to the embodiments described herein.

The foregoing discussion of the invention has been presented for purposes of illustration and description. The foregoing is not intended to limit the invention to the form or forms disclosed herein. In the foregoing description for example, various features of the invention have been identified. It should be appreciated that these features may be combined together into a single embodiment or in various other combinations as appropriate for the intended end use of the band. The dimensions of the component pieces may also vary, yet still be within the scope of the invention. This method of disclosure is not to be interpreted as reflecting an intention that the claimed invention requires more features than are expressly recited in each claim. Moreover, though the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation. Rather, as the following claims reflect, inventive aspects lie in less than all features of any single foregoing disclosed embodiment. Thus, the following claims are hereby incorporated into this Detailed Description, with each claim standing on its own as a separate preferred embodiment of the invention.

What is claimed is:

1. A lock comprising;
a lock body;
a combination locking mechanism located within the lock body, said combination locking mechanism comprising a plurality of dial members, the dial members being rotatable within the lock body; and,
at least one spring integrally formed with the lock body and interacting with the locking mechanism.

2. The lock of claim 1, wherein said at least one spring is selected from the group comprising a leaf spring, a compression spring and a rotational spring.

3. The lock of claim 1, wherein said at least one spring comprises a leaf spring associated with each dial member.

4. The lock of claim 1, wherein said at least one spring comprises a compression spring coaxially aligned with said dials and sleeves to bias the dials and sleeves away from the spring.

5. The lock as claimed in claim 1 wherein the lock body is comprised of a plastic material.

6. The lock as claimed in claim 5, wherein the plastic material is of the polyether type or a polyacetal resin type.

7. The lock as claimed in claim 1, further comprising an interchangeable housing positioned on the exterior of the lock body.

8. The lock as claimed in claim 7 wherein the housing is comprised of a metal selected from the group consisting of steel, stainless steel, brass, copper, aluminum and aluminum alloy.

9. The lock as claimed in claim 1 wherein the housing is comprised of at least two sections.

10. The lock as claimed in claim 1, further comprising a second locking mechanism located within the lock body.

11. The lock as claimed in claim 1, wherein said second locking member is selected from at least one of a key actuated locking mechanism and a combination activated locking mechanism.

12. The lock as claimed in claim 1, further comprising a shackle having a first end and a second end, said shackle operatively associated with said combination locking mechanism.

13. A lock for securing an article, the lock comprising:
a first housing;
a first lock mechanism, wherein at least a portion of the first lock mechanism is located within the first housing; and
biasing means for positioning at least a portion of said first lock mechanism in connection with operation of the lock, said biasing means formed integrally with the first lock housing.

14. The lock as claimed in claim 13, wherein the biasing means comprises at least one of the group comprising a compression spring, a leaf spring and a rotational spring.

15. The lock as claimed in claim 13, wherein the first lock housing and the biasing means are comprised of a plastic material of the polyether type or a polyacetal resin type.

16. The lock as claimed in claim 13, further comprising a second housing adapted to enclose said first housing.

17. The lock as claimed in claim 13, wherein the second lock housing is comprised of at least two sections, the at least two sections enclosing the first lock housing when joined together.

18. The lock as claimed in claim 13, further comprising a second lock mechanism, wherein at least a portion of the second lock mechanism is located within the first housing.

19. The lock as claimed in claim 18, wherein said biasing means interacts with the second lock mechanism.

20. The lock as claimed in claim 19, wherein the first lock mechanism is a combination lock.

21. The lock as claimed in claim 13, further comprising a locking member for engaging at least a portion of the article, the locking member at least partially contained within the first housing and movable upon unlocking the first lock mechanism.

22. In a lock having a first housing, a second housing, a first lock mechanism and a second lock mechanism each having a locked position and an unlocked position, the improvement comprising:
at least one component which interacts with either the first lock mechanism or the second lock mechanism, the at least one component formed integrally with the first lock housing.

23. The lock as claimed in claim 22, wherein the first and second lock mechanism is selected from the group comprising a combination lock mechanism, a key lock mechanism, a biometric lock mechanism, an electronic lock mechanism and a magnetic lock mechanism.

24. The lock as claimed in claim 22, wherein the lock is selected from the group consisting of a padlock, a cable lock, a strap lock, a zipper lock, a cylinder lock and a disc tumbler lock.

25. The lock as claimed in claim 22, wherein the at least one component is selected from the group consisting of a compression spring, a leaf spring and a rotational spring.

26. The lock as claimed in claim 22, wherein said first housing comprises at least two pieces and said first and second lock mechanism are positioned partially within said first housing.

27. The lock as claimed in claim 26, where said second housing comprises at least two pieces and said first housing is at least partially positioned within said second housing.

28. The lock as claimed in claim 22, further comprising an engaging member having a locked position and an unlocked position for engaging a complementary article when the engaging member is in the locked position, the engaging member operatively associated with the first lock mechanism and the second lock mechanism and movable from the locked position to the unlocked position when either the first lock mechanism or the second lock mechanism is in the unlocked position.

29. A system for manufacturing locks, comprising:
providing a plurality of lock bodies, said lock bodies being identical;
providing a plurality of first locking mechanisms;
positioning one of said plurality of first locking mechanisms at least partially within one of said plurality of lock bodies, said one of said plurality of first locking mechanism having a locked state and an unlocked state;
providing a plurality of lock housings adapted to fit on the exterior of said plurality of lock bodies, said plurality of lock housings providing a different appearance to the lock; and
affixing one of said plurality of lock housings to the exterior of said one of said plurality of lock bodies.

30. A system for manufacturing locks of claim 29, further comprising:
positioning a second of said plurality of said first locking mechanisms at least partially within a second one of said plurality of lock bodies; and
affixing a second of said plurality of lock housings to the exterior of said second of said plurality of lock bodies, said second of said plurality of lock housings having a different appearance from said one of said plurality of lock housings.
